(19) United States
(12) Patent Application Publication
(10) Pub. No.: US 2014/0007562 A1
(43) Pub. Date: Jan. 9, 2014

(54) EXHAUST SYSTEM HAVING AN AFTERTREATMENT MODULE

(71) Applicant: Julian JUSTIN, Peoria, IL (US)

(72) Inventor: Julian JUSTIN, Peoria, IL (US)

(21) Appl. No.: 13/541,922

(22) Filed: Jul. 5, 2012

(51) Int. Cl. B01D 53/94; F01N 3/035

(52) U.S. Cl. 60/297; 422/169; 422/310

(57) ABSTRACT

An aftertreatment module for use with an exhaust system is disclosed. The aftertreatment module may have at least one exhaust treatment device, and a generally cylindrical housing configured to receive the at least one exhaust treatment device. The aftertreatment module may also have an inlet integral with the generally cylindrical housing and configured to direct exhaust into the at least one exhaust treatment device, and an outlet integral with the generally cylindrical housing and configured to direct exhaust out of the at least one exhaust treatment device. At least one of the inlet and the outlet may extend in a radial direction of the generally cylindrical housing from an axial location at which an open area of the at least one of the inlet and the outlet at least partially overlaps with the at least one exhaust treatment device.

### TECHNICAL FIELD

The present disclosure is directed to an exhaust system and, more particularly, to an exhaust system having an aftertreatment module.

### BACKGROUND

Internal combustion engines, including diesel engines, gasoline engines, gaseous fuel-powered engines, and other engines known in the art generate a complex mixture of air pollutants. The air pollutants are composed of gaseous compounds (e.g., the oxides of carbon, nitrogen, and sulfur) and solid particulate matter (e.g., unburned carbon particles called soot). Due to increased awareness of the environment, exhaust emission standards have become more stringent, and the amount of air pollutants emitted to the atmosphere by an engine may be regulated depending on the type of engine, size of engine, and/or class of engine.

One method that has been implemented by engine manufacturers to comply with the regulation of emissions has been to remove the gaseous compounds and particulate matter from the exhaust flow of an engine using an exhaust treatment device. An exhaust treatment device can include a filter assembly designed to trap particulate matter, a catalyst (e.g., a diesel oxidation catalyst) located upstream and/or downstream of the filter assembly, an inlet member to direct exhaust flow through the filter assembly, and an outlet member to direct the exhaust flow away from the filter assembly.

An exemplary exhaust treatment device is disclosed in U.S. Pat. No. 7,501,005 that issued to Thaler on Mar. 10, 2009 (“the '005 patent”). The exhaust treatment device includes an inlet module, a filter module, and an outlet module. Each of these modules is connected end-to-end by way of a clamping element.

Although acceptable for some applications, the exhaust treatment device of the '005 patent may be difficult to retrofit into existing machines. Specifically, existing machines may not have been originally designed to accept an exhaust treatment device and, accordingly, may not have large empty spaces within the machine confines to accept an exhaust treatment device. And, the exhaust treatment device of the '005 patent, having inlet, filter, and outlet modules arranged end-to-end may be too large for these applications.

The aftertreatment module of the present disclosure addresses one or more of the needs set forth above and/or other problems of the prior art.

### SUMMARY

One aspect of the present disclosure is directed to an aftertreatment module. The aftertreatment module may include at least one exhaust treatment device, and a generally cylindrical housing configured to receive the at least one exhaust treatment device. The aftertreatment module may also include an inlet integral with the generally cylindrical housing and configured to direct exhaust into the at least one exhaust treatment device, and an outlet integral with the generally cylindrical housing and configured to direct exhaust out of the at least one exhaust treatment device. At least one of the inlet and the outlet may extend in a radial direction of the generally cylindrical housing from an axial location at which an open area of the at least one of the inlet and the outlet at least partially overlaps with the at least one exhaust treatment device.

A second aspect of the present disclosure is directed to a housing for an aftertreatment module. The housing may include a cylindrical inlet portion having a closed end, an open end, and an inlet; and a cylindrical outlet portion having a closed end, an open end, and an outlet. The open end of the cylindrical outlet portion may be configured to axially engage the open end of the cylindrical inlet portion. The housing may also include an internal sleeve integral with one of the cylindrical inlet and outlet portions to form an annular passage in communication with the closed end of the one of the cylindrical inlet and outlet portions. At least one of the inlet and the outlet is radially oriented, axially overlaps at least partially with the internal sleeve, and fluidly communicates with the annular passage.

### BRIEF DESCRIPTION OF THE DRAWING

FIG. 1 is a pictorial illustration of an exemplary disclosed machine;

FIG. 2 is an exploded view pictorial illustration of an exemplary disclosed aftertreatment module that may be used in conjunction with the machine of FIG. 1; and

FIG. 3 is a cross-sectional illustration of the aftertreatment module of FIG. 2.

### DETAILED DESCRIPTION

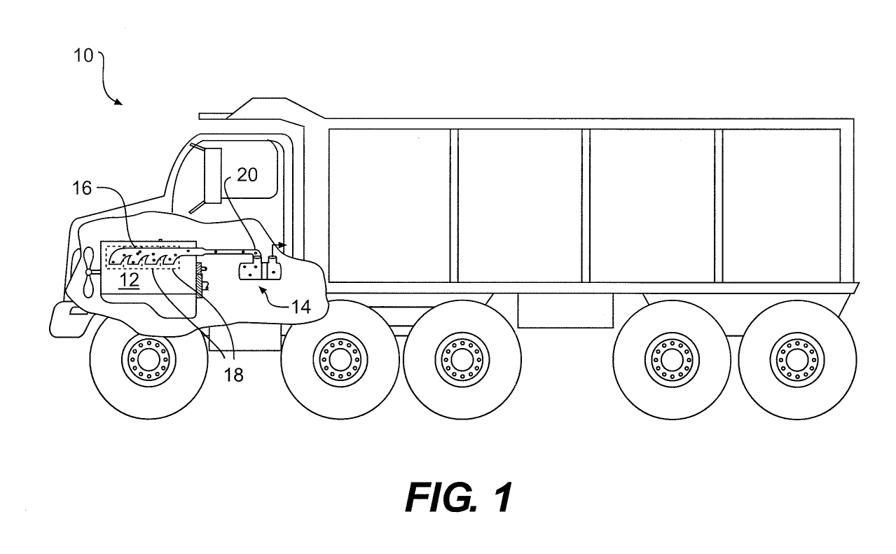

FIG. 1 illustrates an exemplary machine 10. For the purposes of this disclosure, machine 10 is depicted and described as a mobile machine, for example an on-highway haul truck, having one or more multi-cylinder internal combustion engines 12. Engine 12 may be configured to combust a mixture of air and fuel, for example diesel, gasoline, or a gaseous fuel, to generate a mechanical output. The mechanical output from engine 12 may be used to propel machine 10. Alternatively, engine 12 could embody the main or auxiliary power source of a stationary machine such as a pump or a generator set, if desired.

Engine 12 may be equipped with an exhaust system 14 having components that cooperate to promote the production of power and simultaneously control the emission of pollutants to the atmosphere. For example, exhaust system 14 may include one or more exhaust passages 16 fluidly connected to combustion chambers 18 of engine 12, and an aftertreatment module 20 supported by and connected to receive and treat exhaust received from engine 12. Aftertreatment module 20 may convert, treat, condition, and/or otherwise reduce constituents of the exhaust exiting engine 12 before the exhaust is discharged to the atmosphere. It is contemplated that engine 12 may also include a turbocharger (not shown), if desired. When equipped with a turbocharger, the turbocharger may be positioned upstream of aftertreatment module 20.

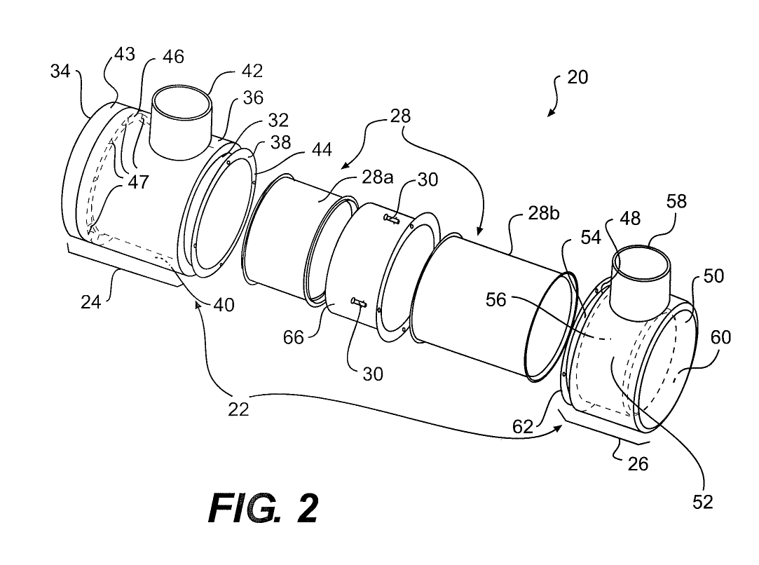

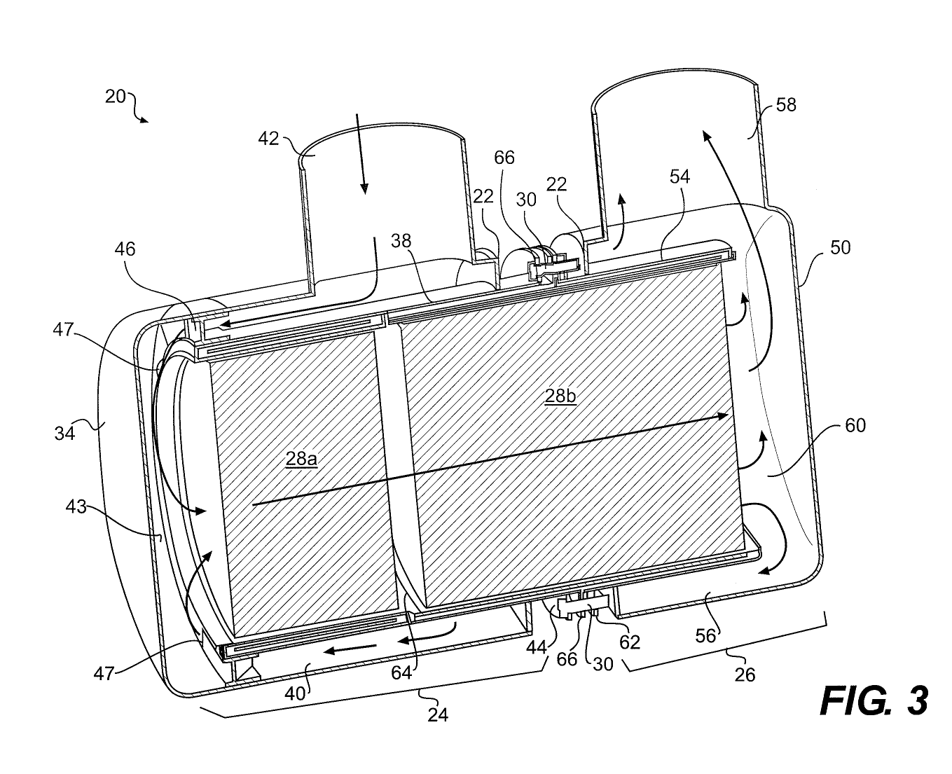

As shown in FIGS. 2 and 3, aftertreatment module 20 may include a generally cylindrical housing 22 having an inlet portion 24, an outlet portion 26, and one or more exhaust treatment devices 28 disposed within one or both of inlet and outlet portions 24, 26. Inlet portion 24 may be axially aligned with and removably connected to outlet portion 26 by way of one or more fasteners 30.

Inlet portion 24 may embody a generally hollow and cylindrical shell fabricated from a corrosion-resistant material, for example from stainless steel. The shell may consist of an open end 32, a closed end 34 located opposite open end 32, and a curved outer surface 36 connecting open end 32 with closed end 34. Inlet portion 24 may be fabricated through a deep draw process, a roll-forming process, a spin-forming process, or another process known in the art, as desired.

A first sleeve 38 may be disposed within the shell of inlet portion 24 to form a first annular passage 40, and an integral inlet 42 may be situated to direct exhaust from engine 12 into first annular passage 40. First sleeve 38 may protrude from open end 32 and extend a distance toward closed end 34. It should be noted that first sleeve 38 may stop short of closed end 34, such that a space 43 exists internally within the shell of inlet portion 24, between closed end 34 and an internal axial end of first sleeve 38. As shown in FIG. 3, inlet 42 may be in communication with space 43 via first annular passage 40. First sleeve 38 may include a flange 44 at an external axial end that is used for connection to outlet portion 26.

Inlet 42 may be generally circular and have a cross-sectional area that is about equal to a cross-sectional area of first annular passage 40. With this configuration, exhaust flowing from inlet 42 into first annular passage 40 may experience little, if any, restriction by first annular passage 40. In the disclosed embodiment, inlet 42 may have a diameter of about 150-155 mm. First annular passage 40 may have an internal diameter of about 265-275 mm, an external diameter of about 360-370 mm (the external diameter of first annular passage 40 may be about the same as the outer diameter of housing 22), and an axial length of about 250-260 mm. Space 43, located internally at the end of first sleeve 38 may have an axial length of about 45-50 mm.

A mixer 46 may be located around first sleeve 38 at the end of first annular passage 40 opposite flange 44. In the disclosed embodiment, mixer 46 may be ring-like and include a plurality of spaced apart vanes 47 that induce swirl in the exhaust as it flows through mixer 46. This swirl may function to mix exhaust with reductant that has been sprayed or otherwise injected into the exhaust at an upstream location (not shown), and to evenly distribute the mixture across a face of exhaust treatment device(s) 28. It is contemplated that mixer 46 may have a different configuration, if desired, or even be omitted if reductant/exhaust mixing is undesired or not required. The length of first annular passage 40 may also be selected to facilitate mixing of exhaust and reductant.

Referring to both FIGS. 2 and 3, outlet portion 26, like inlet portion 24, may also embody a generally hollow and cylindrical shell fabricated from a corrosion-resistant material, for example stainless steel. The shell of outlet portion 26 may include an open end 48, a closed end 50 located opposite open end 48, and a curved outer surface 52 connecting open end 48 with closed end 50. Outlet portion 26 may be fabricated through a deep draw process, a roll-forming process, a spin-forming process, or another process known in the art, as desired.

A second sleeve 54 may be disposed within the shell of outlet portion 26 to form a second annular passage 56, and an integral outlet 58 may be situated to direct treated exhaust from exhaust treatment device(s) 28 into the atmosphere. Second sleeve 54 may protrude from open end 48 and extend a distance toward closed end 50. It should be noted that second sleeve 54 may stop short of closed end 50, such that a space 60 exists internally within the shell of outlet portion 26, between closed end 50 and an internal axial end of second sleeve 54. As shown in FIG. 3, outlet 58 may be in communication with space 60 via second annular passage 56. Second sleeve 54 may include a flange 62 at an external axial end that is used for connection to inlet portion 24.

Outlet 58 may be generally circular and have a cross-sectional area that is about equal to a cross-sectional area of second annular passage 56. With this configuration, exhaust flowing from second annular passage 56 into outlet 58 may experience little, if any, restriction by outlet 58. In the disclosed embodiment, outlet 58 may have a diameter of about 150-155 mm. Second annular passage 56 may have an internal diameter of about 265-275 mm, an external diameter of about 360-370 mm, and an axial length of about 145-150 mm. Accordingly, when outlet portion 26 is connected to inlet portion 24, housing 22 may have an overall length of about 630-640 mm, with a center of inlet 42 being located about 280-290 mm apart from a center of outlet 58. Space 60 located internally at the end of second sleeve 54 may have an axial length of about 45-50 mm.

In the disclosed embodiment, two exhaust treatment devices 28 may be contained within housing 22, including a first exhaust treatment device 28a disposed within inlet portion 24, and a second exhaust treatment device 28b disposed within outlet portion 26. First exhaust treatment device 28a may be an oxidation catalyst, while second exhaust treatment device 28b may be a particulate filter. It is contemplated that a different number and/or different types of exhaust treatment devices 28 may be included within aftertreatment module 20, if desired.

First exhaust treatment device 28a, as an oxidation catalyst, may include a porous ceramic or metallic honeycomb structure, a metal mesh, a metal or ceramic foam, a combination of these materials, or another suitable substrate coated with, impregnated with, or otherwise containing a catalyzing material. The catalyzing material may be, for example, a precious metal that catalyzes a chemical reaction to alter a composition of exhaust passing through aftertreatment module 20. In one embodiment, the catalyzing material may include palladium, platinum, vanadium, or a mixture thereof that facilitates the oxidation of harmful emissions. For example, the catalyzing material may help to convert or otherwise reduce CO, NO, HC, and/or other constituents of the exhaust from engine 12 into harmless substances such as CO₂, NO₂, and H₂O.

In the depicted embodiment, first exhaust treatment device 28a may be arranged in series with and upstream of second exhaust treatment device 28b. A space 64 of, for example, about 25-30 mm may be maintained between first and second exhaust treatment devices 28a, 28b. Space 64 may allow for thermal expansion of first and/or second exhaust treatment devices 28a, 28b, promote an even distribution of exhaust from first exhaust treatment device 28a across second exhaust treatment device 28b, and provide a level of noise attenuation within aftertreatment module 20. First exhaust treatment device 28a may have an outer diameter of about 265-270 mm, and an axial length of about 150-155 mm. It is contemplated that dimensions of first exhaust treatment device 28a may be different and/or that space 64 may be omitted, if desired.

Second exhaust treatment device 28b, as a particulate filter, may be configured to remove particulate matter from the exhaust flow of engine 12. It is contemplated that second exhaust treatment device 28b may be a diesel particulate filter (DPF) including electrically conductive or non-conductive coarse mesh metallic or ceramic elements having openings large enough to allow exhaust to pass through, but small enough to trap a desired size and/or amount of particulate matter. It is also contemplated that second exhaust treatment device 28b may include a catalyst coating, if desired, for reducing an ignition temperature of the particulate matter trapped by second exhaust treatment device 28b. The catalyst coating may support the reduction of HC, CO, and/or particulate matter, and may include, for example, a base metal oxide, a molten salt, and/or a precious metal. Second exhaust treatment device 28b may have an outer diameter of about 265-270 mm, and an axial length of about 300-310 mm. An external face of second exhaust treatment device 28b may be about 480-490 mm from an external face of first exhaust treatment device 28a. It is contemplated that the dimension of second exhaust treatment device 28b may be different, if desired.

In some embodiments, an adapter sleeve 66 may be positioned radially outward of first and second sleeves 38, 54 at an interface of first and second sleeves 38, 54. In this position, adapter sleeve may function as a seal, inhibiting exhaust from leaking from the interface. Adapter sleeve 66 may be resilient and configured to deform during tightening of fasteners 30 to fill gaps and voids between first and second sleeves 38, 54. It is contemplated that adapter sleeve 66 may also function to position first and/or second exhaust treatment devices 28a, 28b, if desired. It is further contemplated that adapter sleeve 66 may be omitted, if desired. When adapter sleeve is omitted, additional sealing elements (not shown) may be included.

FIG. 3 illustrates the relative positioning of the various components of aftertreatment module 20. As can be seen in this figure, inlet 42 and outlet 58 may each be axially positioned to overlap exhaust treatment devices 28 somewhat. In particular, the opening area of inlet 42 may completely overlap exhaust treatment devices 28 (and first sleeve 38) and be located closer to the interface of first and second sleeves 38, 54, while the opening area of outlet 58 may only partially overlap exhaust treatment devices 28 (and second sleeve 54) and be located farther from the interface of first and second sleeves 38, 54

### INDUSTRIAL APPLICABILITY

The aftertreatment module of the present disclosure may be applicable to any machine configuration requiring exhaust constituent conditioning, where component packaging is an important issue. The disclosed aftertreatment module may improve packaging by axially overlapping the location of inlet 42 and outlet 58 with exhaust treatment devices 28. This overlapping may reduce an overall length of aftertreatment module 20.

FIG. 3 illustrates the flow of exhaust through aftertreatment module 20. During operation, exhaust may first enter aftertreatment module 20 in a radially inward direction. From inlet 42, the exhaust may flow around first sleeve 38, and be redirected to flow axially within first annular passage 40 toward closed end 34. Upon reaching the end of first annular passage 40, the exhaust, together with any previously-injected reductant, may pass through mixer 46 and begin to swirl. The swirling mixture may then enter space 43 and be distributed radially inward across the upstream face of first exhaust treatment device 28a. After passing through first exhaust treatment device 28a, the exhaust may then be distributed across the upstream face of second exhaust treatment device 28b. From second exhaust treatment device 28b, the treated exhaust may flow radially outward and into second annular passage 56, and then further radially outward to the atmosphere by way of outlet 58.

Several benefits may be realized by the arrangement of aftertreatment module 20. For example, by locating inlet 42 and outlet 58 to at least partially overlap exhaust treatment devices 28, the overall length of aftertreatment module 20 may be decreased by the amount of overlap. In addition, the complete overlap of inlet 42 and the closer location of inlet 42 to the interface of first and second sleeves 38, 54 may result in a greater axial length of first annular passage 40, which may provide for better mixing of exhaust and reductant within aftertreatment module 20. Further, by locating outlet 58 to extend some distance past the axial end of second sleeve 54 and into space 60, a restriction placed on the flow of exiting exhaust may be reduced.

It will be apparent to those skilled in the art that various modifications and variations can be made to the exhaust system and aftertreatment module of the present disclosure without departing from the scope of the disclosure. Other embodiments will be apparent to those skilled in the art from consideration of the specification and practice of the system and module disclosed herein. It is intended that the specification and examples be considered as exemplary only, with a true scope of the disclosure being indicated by the following claims and their equivalent.

What is claimed is:

1. An aftertreatment module, comprising:
at least one exhaust treatment device;
a generally cylindrical housing configured to receive the at least one exhaust treatment device;
an inlet integral with the generally cylindrical housing and configured to direct exhaust into the at least one exhaust treatment device; and
an outlet integral with the generally cylindrical housing and configured to direct exhaust out of the at least one exhaust treatment device,
wherein at least one of the inlet and the outlet extends in a radial direction of the generally cylindrical housing from an axial location at which an open area of the at least one of the inlet and the outlet at least partially overlaps with the at least one exhaust treatment device.

2. The aftertreatment module of claim 1, wherein both of the inlet and the outlet extend in the radial direction from axial locations at which open areas of the inlet and the outlet at least partially overlap with the at least one exhaust treatment device.

3. The aftertreatment module of claim 2, wherein the inlet is located axially closer to a center of the generally cylindrical housing than the outlet.

4. The aftertreatment module of claim 2, wherein:
the inlet completely overlaps with the at least one exhaust treatment device; and
the outlet extends past an end of the at least one exhaust treatment device.

5. The aftertreatment module of claim 2, wherein:
the at least one exhaust treatment device includes a first exhaust treatment device and a second exhaust treatment device;
the inlet at least partially overlaps the first and second exhaust treatment devices; and
the outlet at least partially overlaps only the second exhaust treatment device.

6. The aftertreatment module of claim 5, wherein the generally cylindrical housing includes:
an inlet portion configured to receive the first exhaust treatment device; and
an outlet portion configured to receive the second exhaust treatment device.

7. The aftertreatment module of claim 6, further including:
a first sleeve fixedly connected within the inlet portion to form a first annular passage around the first sleeve that is in fluid communication with the inlet; and
a second sleeve fixedly connected within the outlet portion to form a second annular passage around the second sleeve that is in fluid communication with the outlet.

8. The aftertreatment module of claim 7, wherein an axial length of the first annular passage is greater than an axial length of the first exhaust treatment device.

9. The aftertreatment module of claim 7, further including an adapter sleeve positioned radially outward of the first and second sleeves at an interface of the first and second sleeves.

10. The aftertreatment module of claim 7, further including a mixer disposed at an end of the first annular passage and configured to mix reductant with exhaust entering the first exhaust treatment device.

11. The aftertreatment module of claim 10, wherein the mixer is annularly shaped and disposed around an end of the first sleeve.

12. The aftertreatment module of claim 7, wherein a cross-sectional area of the first annular passage is about equal to a cross-sectional area of the inlet.

13. The aftertreatment module of claim 12, wherein:
a diameter of the inlet is about 150-155 mm; and
a diameter of the generally cylindrical housing is about 360-370 mm.

14. The aftertreatment module of claim 7, wherein:
an outer face of the first exhaust treatment device is spaced about 480-490 mm away from an outer face of the first exhaust treatment device; and
a center of the inlet is spaced about 280-290 mm away from a center of the outlet.

15. The aftertreatment module of claim 14, wherein an inner face of the first exhaust treatment device is spaced about 25-30 mm away from an inner face of the second exhaust treatment device.

16. The aftertreatment module of claim 14, wherein a first end of the generally cylindrical housing is spaced bout 360-640 mm away from an opposing second end of the generally cylindrical housing.

17. The aftertreatment module of claim 14, wherein an axial length of the first annular passage is about 250-260 mm.

18. The aftertreatment module of claim 5, wherein:
a first axial space is maintained between the first exhaust treatment device and a first end of the generally cylindrical housing; and
a second axial space having about the same length as the first axial space is maintained between the second exhaust treatment device and a second end of the generally cylindrical housing.

19. The aftertreatment module of claim 5, wherein:
the first exhaust treatment device is a diesel oxidation catalyst; and
the second exhaust treatment device is a particulate filter.

20. A housing for an aftertreatment module, comprising:
a cylindrical inlet portion having a closed end, an open end, and an inlet;
a cylindrical outlet portion having a closed end, an open end, and an outlet, the open end of the cylindrical outlet portion configured to axially engage the open end of the cylindrical inlet portion; and
an internal sleeve integral with one of the cylindrical inlet and outlet portions to form an annular passage in communication with the closed end of the one of the cylindrical inlet and outlet portions,
wherein at least one of the inlet and the outlet is radially oriented, axially overlaps at least partially with the internal sleeve, and fluidly communicates with the annular passage.

21. The housing of claim 20, wherein the inlet is located axially closer to the open ends of the cylindrical inlet and outlet portions than the outlet.

22. The housing of claim 20, wherein:
the internal sleeve is a first internal sleeve integral with the cylindrical inlet portion;
the annular passage is a first annular passage in communication with the closed end of the cylindrical inlet portion;
the inlet axially overlaps at least partially with the internal sleeve and fluidly communicates with the first annular passage;
the housing further includes a second internal sleeve integral with the cylindrical outlet portion to form a second annular passage in communication with the closed end of the cylindrical outlet portion; and
the outlet axially overlaps at least partially with the second internal sleeve and fluidly communicates with the second annular passage.

23. The housing of claim 22, wherein:
the inlet completely overlaps with the first internal sleeve; and
the outlet extends past an end of the second internal sleeve.

24. The housing of claim 22, wherein a cross-sectional area of the first annular passage is about equal to a cross-sectional area of the inlet.

25. The housing of claim 24, wherein:
a diameter of the inlet is about 150-155 mm; and
a diameter of the cylindrical inlet and outlet portions is about 360-370 mm.

26. The housing of claim 25, wherein:
a center of the inlet is spaced about 280-290 mm away from a center of the inlet; and
the closed end of the cylindrical inlet portion is spaced bout 630-640 mm away from the closed end of the cylindrical outlet portion.

27. The housing of claim 26, wherein an axial length of the first annular passage is about 250-260 mm.

28. The housing of claim 20, wherein the cylindrical inlet and outlet portions are fabricated from stainless steel.

29. A machine, comprising:
an engine having at least one combustion chamber;
a generally cylindrical housing operatively connected to the engine and including:
a cylindrical inlet portion having a closed end and an open end;
a first sleeve disposed within the cylindrical inlet portion to form a first annular passage;
an inlet protruding radially outward away from the cylindrical inlet portion, the inlet being configured to direct exhaust from the at least one combustion chamber into the first annular passage;
a cylindrical outlet portion having a closed end and an open end, the open end of the cylindrical outlet portion configured to axially engage the open end of the cylindrical inlet portion;
a second sleeve disposed within the cylindrical outlet portion to form a second annular passage;
an outlet protruding radially outward away from the cylindrical outlet portion, the outlet being configured to direct treated exhaust from the second annular passage to the atmosphere;
an oxidation catalyst disposed within the cylindrical inlet portion;
a particulate filter disposed within the cylindrical outlet portion; and
a mixer disposed upstream of the oxidation catalyst at an end of the first annular passage,
wherein:
the inlet is positioned in an axial location at which an open area of the inlet overlaps with the oxidation catalyst and the particulate filter;
the outlet is positioned in an axial location at which an open area of the outlet overlaps at least partially with only the particulate filter; and
an axial length of the first annular passage is greater than an axial length of the second annular passage.
